(19) United States
(12) Patent Application Publication
(10) Pub. No.: US 2018/0121914 A1
(43) Pub. Date: May 3, 2018

(54) Method and System for Authorizing a Payment Transaction

(71) Applicant: Visa International Service Association, San Francisco, CA (US)

(72) Inventor: Cornelius Johannes Badenhorst, Cape Town (ZA)

(21) Appl. No.: 15/561,946

(22) PCT Filed: May 13, 2016
(86) PCT No.: PCT/IB2016/052760

§ 371 Date: Sep. 26, 2017

(30) Foreign Application Priority Data
May 18, 2015 (ZA) 2015/03441

(51) Int. Cl. G06Q 20/40; G06Q 20/32; G06Q 10/08; G06Q 20/12; G06Q 30/06

(52) U.S. Cl. CPC G06Q 20/40; G06Q 20/3224; G06Q 30/06; G06Q 20/12; G06Q 10/08

(57) ABSTRACT

A method of authorizing a payment transaction is provided. The method is carried out at a server that receives a payment request for an order of goods that is placed by a consumer with a merchant. The payment request is associated with payment credentials of the consumer and with delivery information for the delivery of the ordered goods. The server furthermore receives current location information of the ordered goods and determines whether the received current location information matches the received delivery information. If the received current location information matches the received delivery information within acceptable parameters, the payment request is authorized.

### CROSS-REFERENCE TO RELATED APPLICATION

This application claims priority from South African provisional patent application number 2015/03441 filed on 18 May 2015, which is incorporated by reference herein.

### FIELD OF THE INVENTION

This invention relates to payment authorizations and, more particularly, it relates to a method and system for authorizing a payment transaction based on delivery completion.

### BACKGROUND TO THE INVENTION

Electronic commerce, commonly known as e-commerce or eCommerce, has significantly increased in the last several years, with e-commerce sales topping approximately USD 1 trillion in 2012. One of the major drivers behind e-commerce is that it enables merchants to communicate and to form transactions with consumers anytime and anyplace. The reason for this being that e-commerce allows geophysical barriers to disappear, thereby making all consumers and businesses on earth potential customers and suppliers.

E-commerce transactions typically require a consumer to provide his/her payment credentials which may then be used by the merchant to request payment of the applicable amount from a financial institution. Since merchants run the risk that the consumer may repudiate the transaction either before or even after delivery has taken place, thus resulting in the merchant either not receiving the funds or requiring the merchant to make a refund, merchants now typically require the payment to be processed prior to the goods or services being prepared and/or delivered to the consumer.

Nevertheless, by requiring the payment to be processed prior to delivery taking place, the risk that the ordered goods or services are never delivered or are unsuitable for their intended use is moved to the consumer. This has, for obvious reasons, a significant impact on consumer confidence in e-commerce and may have hampered the willingness of some consumers to utilize e-commerce.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with the invention there is provided a method of authorizing a payment transaction, the method being carried out at a server and comprising:
receiving a payment request for an order of goods placed by a consumer with a merchant, the payment request associated with payment credentials of the consumer and delivery information for the delivery of the ordered goods;
receiving current location information of the ordered goods;
determining whether the received current location information matches the received delivery information; and
if the received current location information matches the received delivery information within acceptable parameters, authorizing the payment request.

In one embodiment, the delivery information may include a delivery location. In another embodiment, the delivery information may include a unique identifier associated with an electronic communications device of the consumer. The method may provide for the server to be configured to transmit a location information request to the electronic communications device, that is identified by the unique identifier, to prompt the device to transmit location information of the device to the server; and to, subsequent to receipt thereof, utilise the received location information as delivery information to which the ordered goods are to be delivered.

Even further features provide for the method to include, prior to determining whether the received current location information matches the received delivery information, the pre-processing of a payment request and, subsequently, authorizing the payment request if a match is determined.

Yet further features provide for the current location information to be received by the server from a mobile communications device associated with a delivery agent delivering the ordered goods; from a communications module affixed to the ordered goods; or from an electronic communications device of the consumer.

In one embodiment, the current location information originates from a communications module affixed to the ordered goods and is transmitted via the electronic communication device of the consumer. In an alternative embodiment, the current location information originates from a mobile communication device of a delivery agent and is transmitted via the electronic communications device of the consumer.

Further features provide for the method to include the server receiving a delivery confirmation from an electronic communication device of the consumer that may include information captured from indicia affixed to the ordered goods; and for the indicia to be encoded with at least one unique identifier associated with the payment transaction.

Receiving a delivery confirmation captured from the indicia may include decoded information encoded within the indicia or, alternatively, may include encoded information with the method then including the server decoding the information included in the indicia.

A still further features provide for the delivery confirmation to furthermore include the location of the electronic communication device.

Even further features provide for the server to be configured to, subsequent to receiving the delivery confirmation, determine that the delivered goods are in close proximity to the electronic communication device and therefore that the current location information of the delivered goods matches the delivery information.

Yet further features provide for the payment request to include a payment amount for which payment is requested; and for the method to include the steps of, in response to receiving the payment request, retrieving account information associated with the payment credentials, determining if sufficient funds are available in the account to make payment of the amount requested and, if sufficient funds are available, authorizing the payment request when the current location information matches the delivery information, alternatively, if insufficient funds are available, transmitting a payment failure notification to the merchant and the consumer.

Still further features provide for the method to include the step of, in response to authorizing the payment request, transmitting a payment confirmation to the merchant and the consumer.

Further features provide for the mobile communications device to include any one of a mobile phone, a tablet computer, a personal digital assistant, a laptop computer or the like; for the electronic communications device to include any one of a mobile phone, a tablet computer, a desktop computer, a laptop computer, a personal digital assistant or the like; for the mobile communications device and the electronic communications device to include a location detection system to enable the devices to determine their respective locations; and for the location detection system to include one or more of a Global Positioning System (GPS), a Wireless Positioning System (WPS), a Local Positioning System (LPS), an Indoor Positioning System (IPS) or the like.

The invention extends to a system for authorizing a payment transaction comprising a server including:
a payment request receiving module for receiving a payment request for an order of goods placed by a consumer with a merchant with the received payment request being associated with payment credentials of the consumer and delivery information for the delivery of the ordered goods;
a current location information receiving module for receiving current location information of the ordered goods;
a location match determining module for determining whether the received current location information matches the received delivery information; and
a payment authorization module for authorizing the payment request if the received current location information matches the received delivery information within acceptable parameters.

Further features provide for the system to include a location information request transmitting module that is configured to transmit a location information request to an electronic communications device, identified by a unique identifier in the delivery information, so as to prompt the device to transmit location information of the device to the server.

Still further features provide for the system to include an available funds determining module for pre-processing a payment request prior to determining whether the received current location information matches the received delivery information; and a payment authorizing module for authorizing the payment request if a match is determined.

The current location receiving module may receive the current location information, in one embodiment, from a mobile communications device associated with a delivery agent delivering the ordered goods; in an alternative embodiment, from a communications module affixed to the ordered goods; and, in a further alternative embodiment, from an electronic communications device of the consumer.

Further features provide for the current location information receiving module to receive a delivery confirmation from an electronic communications device of the consumer that includes information captured from an indicia affixed to the ordered goods that is encoded with at least one unique identifier associated with the payment transaction that is transmitted via the electronic communications device of the consumer to the server.

Still further features provide for the system to include a mobile communications device of a delivery agent that is configured to transmit the current location information of the ordered goods; a communications module affixed to the ordered goods that is configured to transmit the current location information of the ordered goods; or an electronic communications device of the consumer that is configured to transmit the current location information of the ordered goods originating from a communications module or indicia affixed to the ordered goods.

Further features provide for the payment request to include a payment amount for which payment is requested; for the server to include an account information retrieving module for, in response to receiving the payment request, retrieving account information associated with the payment credentials; for the server to include an available fund determining module for determining if sufficient funds are available in the account to make payment of the amount requested; and a payment failure notification transmitting module for transmitting a payment failure notification to the merchant and the consumer if insufficient funds are available in the account to make the requested payment.

Still further features provide for the server to include a payment confirmation transmitting module for, in response to authorizing the payment request, transmitting a payment confirmation to the merchant and the consumer.

The invention extends to a computer program product for authorizing a payment transaction, the computer program product comprising a non-transitory computer-readable medium having stored computer-readable program code, the computer-readable program code executable by a processing circuit to perform the steps of:
receiving a payment request for an order of goods placed by a consumer with a merchant, the payment request associated with payment credentials of the consumer and delivery information for the delivery of the ordered goods;

receiving current location information of the ordered goods;
determining whether the received current location information matches the received delivery information; and
if the received current location information matches the received delivery information within acceptable parameters, authorizing the payment request.

Further features provide for the payment request to include a payment amount for which payment is requested; and for the processing circuit to perform the further steps of, in response to receiving the payment request, retrieving account information associated with the payment credentials, determining if sufficient funds are available in the account to make payment of the amount requested and, if sufficient funds are available, authorizing the payment request when the current location information matches the delivery information, alternatively, if insufficient funds are available, transmitting a payment failure notification to the merchant and the consumer.

An embodiment of the invention will now be described, by way of example only, with reference to the accompanying drawings.

### BRIEF DESCRIPTION OF THE DRAWINGS

In the drawings:

FIG. 1 illustrates a system for authorizing a payment transaction according to an embodiment of the invention, in which the current location information is transmitted to the server by means of a mobile communications device of the delivery agent;

FIG. 2 is a swim lane flow diagram illustrating a method of authorizing a payment transaction using the system of FIG. 1;

FIG. 3 illustrates a system for authorizing a payment transaction according to an alternative embodiment of the invention, in which a communications module is secured to the ordered goods and the current location information is transmitted to the server by means of an electronic communications device of the consumer;

FIG. 4 is a swim lane flow diagram illustrating a method of authorizing a payment transaction using the system of FIG. 3;

FIG. 5 illustrates a system for authorizing a payment transaction according to yet a further alternative embodiment of the invention, in which the delivery information includes at least one unique identifier of an electronic communications device of the consumer;

FIG. 6 is a swim lane flow diagram illustrating a method of authorizing a payment transaction using the system of FIG. 5;

FIG. 7 illustrates a system for authorizing a payment transaction according to still a further alternative embodiment of the invention, in which the current location information is transmitted to the server by use of indicia affixed to the ordered goods;

FIG. 8 is a swim lane flow diagram illustrating a method of authorizing a payment transaction using the system of FIG. 7;

FIG. 9 is a block diagram which illustrates an example of a server;

FIG. 10 illustrates an example of a computing device in which various aspects of the disclosure may be implemented; and

FIG. 11 shows a block diagram of a communications device that may be used in embodiments of the disclosure.

### DETAILED DESCRIPTION WITH REFERENCE TO THE DRAWINGS

Embodiments described herein provide a method and system for authorizing a payment transaction. Payment transactions may include any form of payment transaction including card-present transactions, such as debit or credit card transactions, card-not-present transactions, electronic funds transfer (EFT), or payment transactions using a mobile wallet, a token, a voucher, loyalty card or the like. In addition, embodiments of the method and system described may be used for any transaction concluded between a consumer and a merchant in which goods are delivered to the consumer.

The described method and system for authorizing a payment transaction are carried out at a payment authorizing server which may be provided by or in communication with a financial institution or payment services provider. A payment request for an order of goods placed by a consumer with a merchant may be received at the server and the payment request may include payment credentials of the consumer and delivery information for the delivery of the ordered goods. The delivery information may include a delivery location for the ordered goods or may, alternatively, include an identifier of a consumer's electronic communication device such as a mobile phone having a location service such that the goods may be delivered to the consumer based at their mobile phone's location. The method and system match a current location information of the ordered goods to the delivery information, and if the received current location information matches the received delivery information, the payment request is authorized by the server.

Embodiments of the method and system disclosed herein may provide a number of advantages over known methods. For example, since the payment transaction is only authorized once the delivery of the ordered goods has taken place, the risk of delivery of the goods or the suitability thereof at delivery is moved from the consumer to the merchant. This may be of particular importance for e-commerce transactions since it may increase consumer confidence in e-commerce transactions.

Various embodiments of the method and system are described and it will be apparent that additional variations or combinations of features may provide further embodiments. In particular, the current location information of the ordered goods may be provided to the server directly from a mobile communication device of a delivery agent or directly from a communication module affixed to the ordered goods. In other embodiments, the current location information of the ordered goods may be provided via a consumer's electronic communication device. For example, a delivery agent's mobile communication device or a communication module of the goods may communicate with the server via the consumer's electronic communication device. In another example, the ordered goods may have indicia, such as a barcode or Quick Response (QR) code which may be captured by the consumer's electronic communication device.

Due to the various embodiments which are envisaged, the delivery of the ordered goods may be made by the merchant, by a delivery agent, by a drone delivery, by a postal or courier delivery, or any other form of delivery.

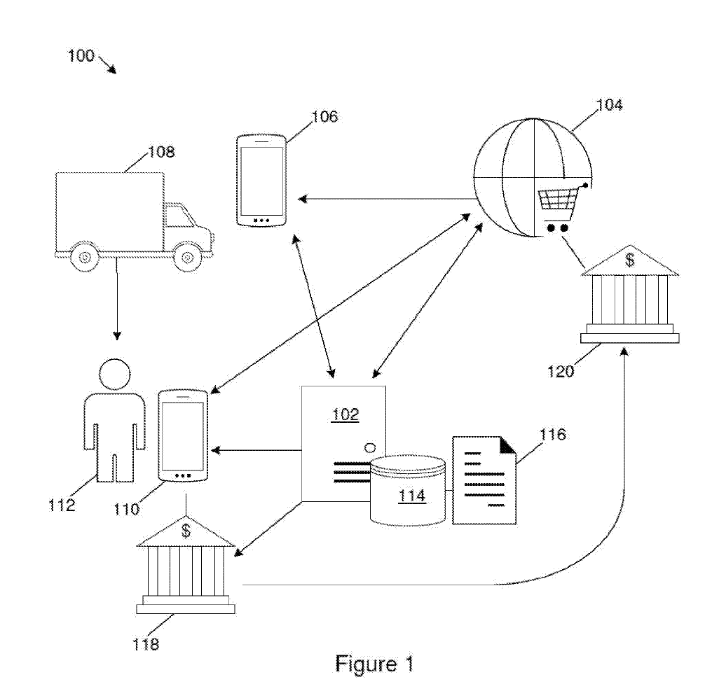

FIG. 1 illustrates a system (100) for authorizing a payment transaction according to an embodiment of the invention in which the current location information is transmitted to a payment authorizing server by means of a mobile communications device of a delivery agent.

The system (100) includes a payment authorizing server (102) (referred to generally as “the server”) which may be in communication with a merchant device (104) either directly or via an intermediate service. The payment authorizing server (102) may be provided by a financial institution or payment services provider. The merchant device (104) may be any form of computing device or server providing sales transactions for goods which may be delivered to a consumer (112). In one embodiment, the merchant device (104) may provide an e-commerce merchant service through which a consumer may order goods for delivery.

The payment authorizing server (102) may also be in communication with a mobile communications device (106) of a delivery agent (108) and, in some embodiments, in communication with an electronic communications device (110) of a consumer (112). In one embodiment, both the mobile communications device (106) and the electronic communications device (110) are mobile phones, but any other suitable devices may be used. For example, the mobile communications device may also be a tablet computer, a personal digital assistant, a laptop computer, a dedicated mobile communications device or handheld terminal commonly used by delivery agents or the like. Similarly, the electronic communications device may also be a tablet computer, a desktop computer, a laptop computer, a personal digital assistant or the like.

Communication between the server (102) and each of the merchant device (104), the mobile communications device (106) of the delivery agent and the electronic communications device (110) of the consumer as required may take place over any suitable communications channel, including third generation (3G), fourth generation (4G), high-speed downlink packet access (HSDPA), general packet radio service (GPRS), short message service (SMS), unstructured supplementary service data (USSD) communication protocols. In a preferred embodiment, the mobile communications device (106) and the electronic communications device (110) are capable of directly communicating with the server (102), however, it is envisaged that this will not always be possible and in such cases the devices may also be enabled to communicate with the server (102) utilizing a local wireless network or utilizing the communication capabilities of another communications device, such as a mobile phone or the like.

Furthermore, each of the mobile communications device (106) of the delivery agent and the electronic communications device (110) of the consumer may include a location detection system (not shown) which enables the devices (106, 110) to determine their respective locations. The location detection system may be any suitable system including one or more of a Global Positioning System (GPS), a Wireless Positioning System (WPS), a Local Positioning System (LPS), an Indoor Positioning System (IPS) or the like. Nevertheless, it is envisaged that this will also not always be possible and that the devices (106, 110) may be enabled to communicate with other electronic devices that are capable of determining their location and to communicate the location information to the mobile communications device (106) or the electronic communications device (110). For example, in the event that the mobile communications device (106) is not capable of determining its own location, it may be configured to communicate with the GPS of the delivery vehicle and thereby determine its own location based on the location information received from the GPS of the vehicle.

The system (100) may also include a database (114) associated with the server (102). The database (114) may contain account information of a plurality of consumers as well as a list (116) of unique identifiers of electronic communication devices (110) as will be described in more detail further below. In addition, the system (100) further includes one or more financial institutions, in this embodiment a first bank (118) of the consumer (112) and a second bank (120) of the merchant. It will be appreciated that the financial institutions do not need to be banks and could also be entities which provide services of a financial nature, such as entities which offer mobile wallet, token, voucher, loyalty card or other services. It will furthermore be appreciated that the first and second banks (118, 120) do not need to be separate entities, but may be two financial accounts managed by the same financial institution, the accounts being associated with the consumer (112) and the merchant respectively.

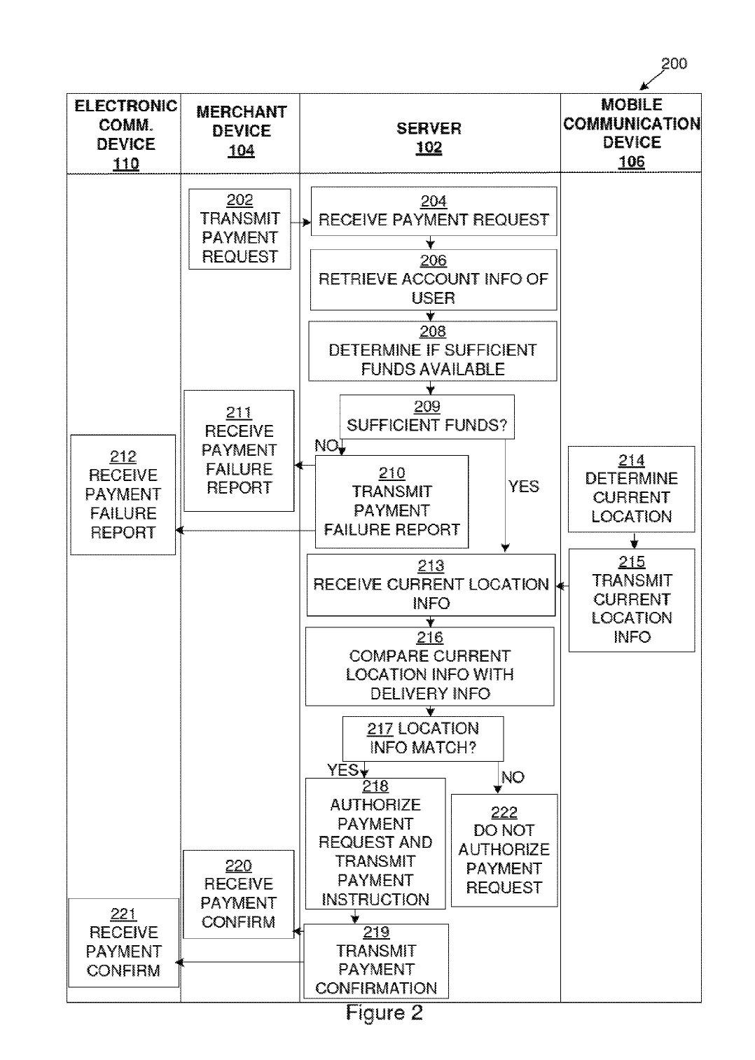

The system (100) of FIG. 1 may be used according to the method described and illustrated in the embodiment of the swim lane diagram (200) of FIG. 2.

Referring to FIG. 2, one embodiment of a method for authorizing a payment transaction is described. When a consumer (112) purchases goods from the e-commerce merchant over the Internet, for example, by using the merchant's e-commerce website on the consumer's electronic communications device (110), the consumer (112) will be required to provide his/her payment credentials as well as delivery information for the delivery of the ordered goods. The payment credentials may include any suitable credentials required for the payment option selected, such as for a credit or debit card payment the credentials will typically include the credit or debit card number, the Card Verification Value (CCV) number, the expiry date of the card and the cardholder name. Once this information has been provided to the merchant, the merchant device (104) transmits (202) a payment request to the server (102). In some cases, there may be a payment service which communicates with the server on behalf of the merchant or the payment credentials may be provided by the consumer directly to the server, for example by payment service re-routing from the merchant's web site.

The payment request may include the payment credentials of the consumer (112), the delivery information for the delivery of the ordered goods and the payment amount for which payment is requested. The request may also include payment credentials of the merchant to indicate where payment should be made to. The delivery information may provide an address for delivery of the ordered goods which may be converted to directions or coordinates for use by the delivery agent.

Parameters of acceptable ranges of variation from a delivery location may be calculated by the server, for example by consulting a mapping service for a location, or may be provided by the consumer. A current location may therefore, in certain embodiments, be determined to match a desired delivery location if the current location falls within a geo-fence of predetermined dimensions.

The server (102) then receives (204) the payment request and subsequently retrieves (206) account information associated with the payment credentials of the consumer (112). The account information is preferably retrieved from the database (114), however, the server (102) may also be configured to retrieve the information by requesting it from the financial institution (118) of the consumer (112), for example.

Once the account information has been retrieved then the server (102) may optionally determine (208) whether sufficient funds are available in the account of the consumer (112) to make payment of the payment amount requested in the payment request. If insufficient funds are available (209), the server (102) transmits (210) a payment failure report to both the merchant device (104) and the electronic communication device (110) of the consumer (112). In this embodiment, the report is transmitted to the electronic communications device (110) of the consumer (112), however, it may also be transmitted to the consumer by means of an email to a designated email account or the like. The payment failure report will be received (211) by the merchant device (204) as well as received (212) by the electronic communications device (110) of the consumer (112).

Alternatively, if sufficient funds are available (209), the method proceeds. It may be that the sufficiency of funds is checked before ordered goods are dispatched. Optionally, a pre-processing of payment for the ordered goods may be secured awaiting final confirmation of delivery before the payment is finalized.

The server (102) may receive (213) current location information of the ordered goods. In this embodiment, the current location information is transmitted to the server (102) from the mobile communications device (106) of the delivery agent (108) and includes the geographical location thereof. In a preferred embodiment, the mobile communications device (106) continuously determines (214) its location via the location detection system and then transmits (215) the current location information to the server (102). However, it will be appreciated that this may be inconvenient and that it may also only be done once the delivery agent (108) has delivered the ordered goods. In this case, the delivery agent (108) may be required to access a mobile device application resident on the mobile communications device (106) to indicate that delivery has been completed, and in response to which the mobile communications device (106) then transmits its current location information determined by means of the location detection system to the server (102). Alternatively, the server (102) may also be configured to continuously transmit current location information requests to the mobile communications device (106), in response to which the mobile communications device then determines its location and transmits the current location information to the server (102).

Subsequently, the server (102) compares (216) the current location information received from the mobile communications device (106) with the delivery information included in the payment request to determine whether they match within configured parameters. If (217) the current location information matches the delivery information, the server (102) authorizes (218) the payment request and transmits a payment instruction to the financial institution (118) of the consumer (112) to make payment of the payment amount to the financial institution (120) of the merchant.

It will be appreciated that if it is determined that the current location information matches the delivery information, but prior to the server (102) authorizing the payment transaction, the server (102) may be configured to transmit an approval request notification to the electronic communications device (110) of the consumer (112). This may be sent directly to the electronic communications device (110) of the consumer (112) or via the merchant device (104) if there is no direct communication between the server (102) and the consumer (112). The notification may prompt the consumer (112) to confirm that the ordered goods have been delivered in a satisfactory condition by transmitting a notification to that effect to the server (102). Once the ordered goods have been approved, the server (102) may then authorize the payment transaction.

At a next step (219), the server (102) may then transmit a payment confirmation to the merchant device (104) and the electronic communication device (110) of the consumer (112). The payment confirmation may be received (220) by the merchant device (204) as well as received (221) by the electronic communications device (110) of the consumer (112).

Alternatively, if no match is determined (217) between the current location information and the delivery information, then the payment transaction will not be authorized. The server (102) may be configured to cancel the payment request after a predetermined failure criteria is met, such as a specific period of time having elapsed after the payment request, for example. The server (102) may then transmit a failure notification to both the electronic communication device (110) of the consumer (112) and the merchant device (104).

Further, it will be appreciated that since the payment transaction is only authorized once the location of the ordered goods matches the location to which the goods are to be delivered, that the risk of delivery of the goods is moved from the consumer to the merchant. Furthermore, since the consumer will typically accept the delivery personally, he/she may be able to refuse taking delivery of the goods if they are not delivered in a suitable condition.

Furthermore, although the delivery agent is represented in the drawings as a delivery vehicle in the form of a delivery truck, the system and method can be equally employed for so called drone or unmanned vehicles delivery. In such an embodiment, the drone or unmanned vehicle may incorporate the mobile communications device and once the delivery has been completed it may directly communicate with the server.

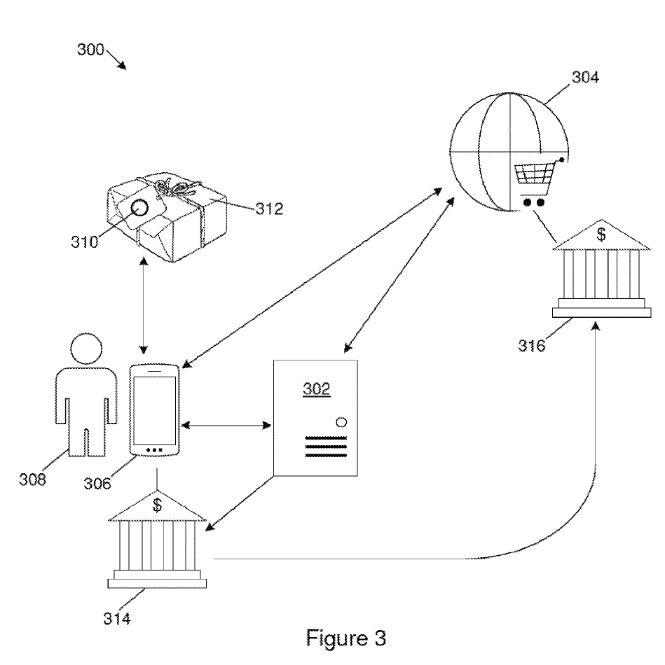

FIG. 3 illustrates a system (300) for authorizing a payment transaction according to another embodiment of the invention in which a communications module is secured to the ordered goods and the current location information is transmitted to the server by means of an electronic communications device of the consumer. In this system (300), the current location information is not determined by a mobile communications device of the delivery agent.

The system (300) again includes a server (302) in communication with a merchant device (304), in this embodiment again an e-commerce merchant, and an electronic communications device (306) of a consumer (308). In this embodiment, the electronic communications device (306) is again a mobile phone. In addition, the system (300) includes a communications module (310) that is capable of communicating with the electronic communications device (306) of the consumer (308) when in close proximity thereto.

In a preferred embodiment and as illustrated in FIG. 3, the communications module (310) is secured to the packaging of the ordered goods (312) and is generally in a dormant state. The module is only capable of communicating when in close proximity to an electronic device that is configured, typically by means of having an electronic device application installed thereon, to initiate communication with the communications module (310). Thus, depending on pre-set parameters, as soon as the communications module (310) is brought within a range of about 5 to 10 meters of the electronic communications device (306), the communications module (310) and the device (306) will recognise each other's presence and initiate communication. It will be appreciated that the communication may be as little as an indication that the communications module (310) is in close proximity, but could also include communication relating to specific characteristics of the device, such as the state of the communications module (310), whether there has been tampering with the module (310) or the like.

In addition, the electronic communications device (306) of this embodiment is configured to communicate with the server (302). Once the electronic communications device (306) is capable of communicating with the communications module (310), it will communicate its current location information and indirectly, due to their close proximity, that of the communications module (310) to the server (302). Therefore, since the electronic communications device (306) is configured to communicate to the server (302) the current location information only upon the communications module (310) being in close proximity thereto, the server (302) may be configured to determine that once it receives the current location information that the current location information matches the delivery information and hence authorize the payment request.

In one scenario, the delivery information may be a delivery address in which case the current location information received from the consumer's electronic communications device (306) indicating the current location information of the ordered goods may be compared to the delivery address location. In another scenario, the delivery information may identify a consumer's electronic communication device (306), for example, by a MSISDN number in the case of a mobile phone, and may match the location of the electronic communication device (306) having the identifier to the received current location information.

In one embodiment, the communications module may be capable of directly communicating with the server once in close proximity to the electronic communications device. In such an embodiment the communications module may require a power source. Contingent on the type of module, its radio frequency technology and communication protocol, the module may also require medium to long distance communication capabilities. This may necessitate a device that is substantially bigger and more expensive than the generally dormant module described above.

In an alternative embodiment, the communications module may furthermore be capable of determining its own location and to transmit the location to the server as the current location information. Once the ordered goods have then been delivered to the consumer, the current location information transmitted by the module will match the delivery information and the server will authorize the payment transaction.

The communications module (310) may be a passive module, such as a radio-frequency identification (RFID) tag, which harvests energy emitted by the electronic communication device (306) through electromagnetic induction, when in close proximity thereto. This provides the communications module (310) with sufficient energy to enable data transfer of a unique identifier to the electronic communications device (306). The communications module (310) may also be an active module, such as a Bluetooth® Low Energy (BLE) beacon, that periodically transmits a unique identifier that may be received and interpreted by the electronic communication device (310) when within its vicinity. The electronic communication device (306) may be configured to automatically launch a relevant software application upon detection of the beacon signal. Such BLE beacons are manufactured by various vendors and operate using proximity beacon protocols such as iBeacon® from Apple® and Eddystone® from Google®. These exemplary communications modules are for illustration purposes and does not constitute an exhaustive list.

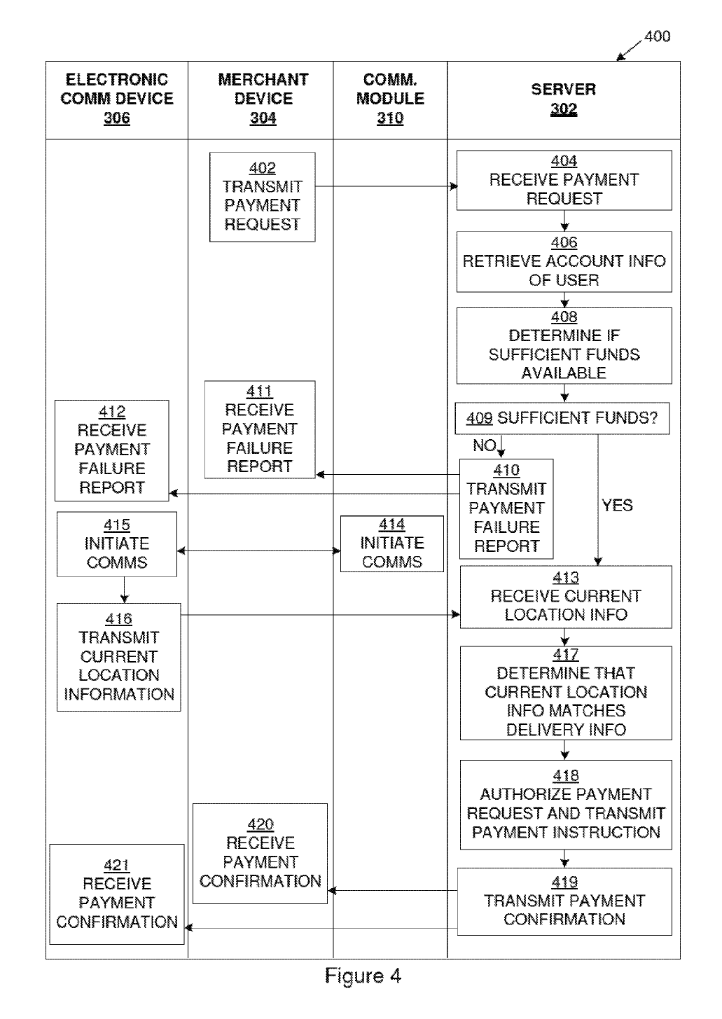

The system (300) of FIG. 3 may be used according to the method described and illustrated in the embodiment of the swim lane diagram (400) of FIG. 4.

Referring to FIG. 4, one embodiment of a method for authorizing a payment transaction is described. When a consumer (308) purchases goods (312) from an e-commerce merchant over the Internet, for example, by using the merchant's e-commerce website on the consumer's electronic communications device (306), the consumer (308) may be required to provide his/her payment credentials as well as delivery information for the delivery of the ordered goods. Once this information has been provided to the merchant device (304), it transmits (402) a payment request to the server (302). The payment request may include the payment credentials of the consumer (308), the delivery information for the delivery of the ordered goods (312) and the payment amount for which payment is requested. The request may also include payment credentials of the merchant to indicate where payment should be made to.

The server (302) then receives (404) the payment request and, subsequently, retrieves (406) account information associated with the payment credentials of the consumer (308). The account information is again preferably retrieved from a database (314) associated with the server (302).

Once the account information has been retrieved, the server (302) determines (408) whether sufficient funds are available in the account to make payment of the payment amount requested in the payment request. If (409) insufficient funds are available, the server (302) transmits (410) a payment failure notification to both the merchant device (304) and the electronic communication device (306) of the consumer (308). The payment failure report may be received (411) by the merchant device (304) as well as received (412) by the electronic communications device (306) of the consumer (308).

Alternatively, if sufficient funds are available, the server (302) receives (413) current location information of the ordered goods. As described with reference to FIG. 3, the communications module (310) may be dormant until it is in close proximity to the electronic communications device (306) and therefore the server (302) will only receive the current location information at time of delivery of the ordered goods (312). Therefore, once the module (310) and the electronic communications device (306) are capable of communicating (414, 415) with each other, the electronic communications device (304) will transmit (416) the current location information to the server (302).

As explained above, the server (302) receives (413) the current location information from the electronic communications device (306) once the communications module (310) is in close proximity thereto and may be configured to subsequently determine (417) whether the current location information matches the delivery information. Once determined that the current location information matches the delivery information, the server (302) authorizes (418) the payment request and transmits a payment instruction to a financial institution (314) of the consumer (308) to make payment of the payment amount to a financial institution (316) of the merchant.

Similarly to the system and method described with reference to FIGS. 1 and 2, it will be appreciated that once it has been determined that the current location information matches the delivery information, but prior to the server (302) authorizing the payment transaction, the server (302) may be configured to transmit an approval request notification to the electronic communications device (306) of the consumer (308). The notification will prompt the consumer (308) to confirm that the ordered goods have been delivered in a satisfactory condition by transmitting a notification to that effect to the server (302). Once the ordered goods have been approved, the server (302) will then authorize the payment transaction.

Once the payment transaction has been authorized, the server (302) transmits (419) a payment confirmation to the merchant device (304) and the electronic communication device (306) of the consumer (308). The payment confirmation may be received (420) by the merchant device (304) as well as received (421) by the electronic communications device (306) of the consumer (308).

It will again be appreciated that delivery of the ordered goods may take place by any suitable means including conventional delivery by means of a delivery agent driving a vehicle or by means of drone or unmanned vehicles delivery to name but a few exemplary delivery methods.

In one embodiment, the packaging of the ordered goods (312) may be a reusable, secure container. In such an embodiment, the container wherein the ordered goods (312) are transported may include an integrated communications module, as opposed to attaching a discrete communication module to the packaging.

In another embodiment, the communication module may include or be in communication with one or more sensors that measure and record environmental and transport conditions to which the ordered goods are exposed. These measurements may include acceleration or mechanical shock, temperature, humidity and atmospheric pressure to mention but a few examples. The communication module (310) may furthermore be able to communicate these measurements directly to the electronic communication device (306) of the consumer (308). The electronic communication device (306) may in turn present these readings to the consumer (308) by means of an application installed thereon. Alternatively, the communications module (310) may communicate these measurements directly to the server (302) to be presented to the consumer (312) in an approval prompt. The server (302) and/or electronic communication device (310) may be configured to only present these readings if the measurements fall outside certain preconfigured limits.

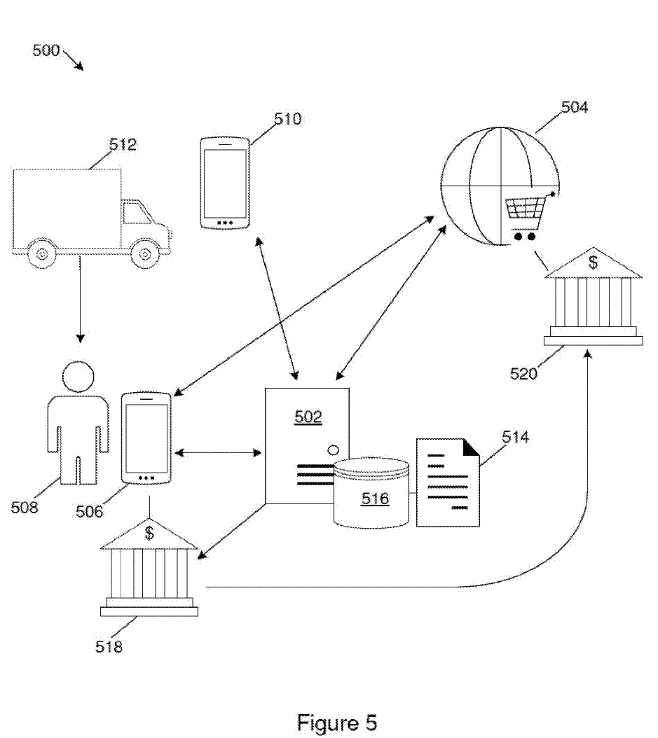

FIG. 5 illustrates a system (500) for authorizing a payment transaction according to yet a further alternative embodiment of the invention in which the delivery information includes at least one unique identifier of an electronic communications device of the consumer. In this system (500) the delivery information may vary and not be constant.

The system (500) again includes a server (502) in communication with a merchant device (504), in this embodiment again an e-commerce merchant, and an electronic communications device (506) of a consumer (508). In this embodiment, the electronic communications device (506) is again a mobile phone. In addition, the system includes a mobile communications device (510) of a delivery agent (512) who delivers the ordered goods to the location identified in the delivery information.

The electronic communications device (506) of the consumer (508) and preferably the mobile communications device (510) of the delivery agent (512) both include a location detection system (not shown) which enables the devices (506, 510) to determine their respective locations.

In this embodiment, when the consumer (508) has placed an order with the merchant and the merchant device (504) transmits a payment request to the server (502), the payment request includes at least one unique identifier of the one or more electronic communications devices (506) of the consumer (508). In this embodiment, the consumer (508) only has one electronic communications device (506), the mobile phone, but it will be appreciated that the consumer (508) could have a number of similar devices.

The server (502) may be configured to utilize the one or more unique identifiers in order to transmit a location information request to the identified electronic communications device (506) so as to prompt the device (506) to determine its location and to transmit the location information to the server (502). The server (502) may then be configured to utilize this location information as the delivery information to which delivery of the ordered goods is to take place. The server (502) may be further configured to transmit the location information to the mobile communications device (510) of the delivery agent (512) so as to enable the delivery agent (512) to deliver the ordered goods.

It will be appreciated that the server (502) may be configured to continuously transmit location information requests to the identified electronic communications device (506) so as to continuously update the delivery information. This will be of particular relevance where the electronic communications device (506) is a mobile device and can therefore be carried to various locations by the consumer (508). In this case the delivery agent (512) may be continuously updated with the consumer's current location so as to enable delivery to take place at whichever location the consumer (508) may be.

In addition, it will further be appreciated that the payment request may only include one unique identifier as will be the case where the electronic communications device is the consumer's desktop computer. In such a case, the server (502) may be configured to compare the received unique identifier with a list (514) of identifiers stored on a database (516) and retrieve additional unique identifiers associated with the received unique identifier. This will enable to server (502) to identify the unique identifier of, for example, the consumer's mobile phone, and transmit location information requests to the mobile phone rather than the desktop computer.

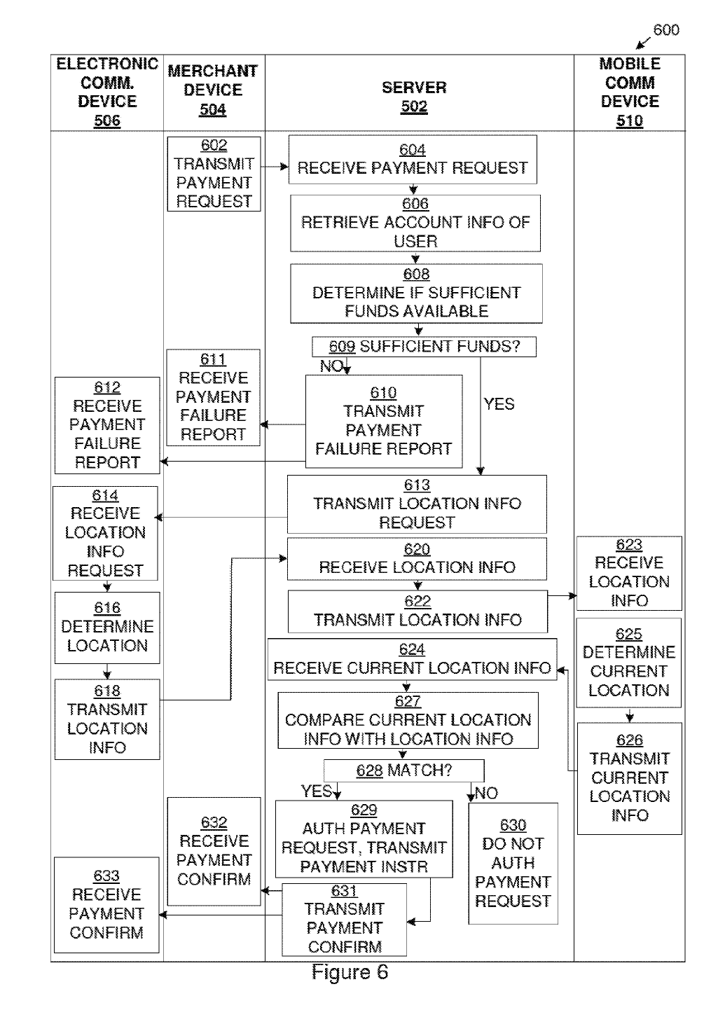

The system (500) of FIG. 5 may be used according to the method described and illustrated in the embodiment of the swim lane diagram (600) of FIG. 6.

Referring to FIG. 6, one embodiment of a method for authorizing a payment transaction is described. When a consumer (508) purchases goods from the e-commerce merchant over the Internet, for example, by using the merchant's e-commerce website on the consumer's mobile phone, the consumer (508) will be required to provide his/her payment credentials as well as delivery information for the delivery of the ordered goods. The delivery information includes at least one unique identifier of one or more electronic communications devices of the consumer (508). In this embodiment, the unique identifier is International Mobile Subscriber Identity (IMSI) number of the mobile phone. Once this information has been provided to the merchant device (504), the merchant device (504) transmits (602) a payment request to the server (502). The payment request will include the payment credentials of the consumer (508), the delivery information for the delivery of the ordered goods and the payment amount for which payment is requested. The request may also include payment credentials of the merchant (504) to indicate where payment should be made to.

The server (502) then receives (604) the payment request and subsequently retrieves (606) account information associated with the payment credentials of the consumer (504). The account information is preferably retrieved from the database (516), however, the server (502) may also be configured to retrieve the account information by requesting it from a financial institution (518) of the consumer (508), for example.

Once the account information has been retrieved, the server (502) determines (608) whether sufficient funds are available in the account to make payment of the payment amount requested in the payment request. If (609) insufficient funds are available, the server (502) transmits (610) a payment failure report to both the merchant device (504) and the electronic communications device (506) of the consumer (508). The payment failure report may be received (611) by the merchant device (504) as well as received (612) by the electronic communications device (516) of the consumer (508).

Alternatively, if sufficient funds are available, the server (502) transmits (613) a location information request to the mobile phone (506) of the consumer (508) requesting the mobile phone (506) to provide its location information. The mobile phone (506) then receives (614) the location information request and subsequently determines (616) its location by using its location detection system. When determined, the mobile phone (506) transmits (618) the location information to the server (502).

The server (502) receives (620) the location information and subsequently transmits (622) the location information to the mobile communications device (510) of the delivery agent (512), which is subsequently received (623) thereat.

This location information may then be used by the delivery agent as the delivery information to which the ordered goods are to be delivered. It will be appreciated that the server (502) may be configured to determine that the location information received from the mobile phone (506) is the delivery information at which delivery of the ordered goods is to take place.

In addition the server (502) receives (624) current location information of the ordered goods. In this embodiment, the current location information is transmitted (626) to the server (502) from the mobile communications device (510) of the delivery agent (512) which it determines (625) using its location detection system.

It will be appreciated that the mobile communications device (510) may continuously determine its location via the location detection system and then transmit the current location information to the server (502). However, it will be appreciated that this may be inconvenient and that it may also only be done once the delivery agent (512) has delivered the ordered goods. In this case, the delivery agent (512) may be required to access a mobile device application resident on the mobile communications device (510) to indicate that delivery has been completed, and in response to which the mobile communications device (510) then transmits its current location information determined by means of the location detection system to the server (502). Alternatively, the server (502) may also be configured to continuously transmit current location information requests to the mobile communications device (510), in response to which the mobile communications device (510) then determines its location and transmits the current location information to the server (502).

The server (502) then determines, by comparing (627) the location information received from the mobile phone (506) with the current location information received from the mobile communications device (510) of the delivery agent (512), whether the current location information matches the delivery or location information of the mobile phone (512).

If (628) the current location information matches the delivery information the server (502) authorizes (629) the payment request and transmits a payment instruction to the financial institution (518) of the consumer (508) to make payment of the payment amount to the financial institution (520) of the merchant. If (628), however, there is no match, the payment request will not be authorized (630).

The method may also include the additional step of transmitting an approval request notification to the electronic communications device (506) of the consumer (508). The notification will prompt the consumer (508) to confirm that the ordered goods have been delivered in a satisfactory condition by transmitting a notification to that effect to the server (502). Once the ordered goods have been approved, the server (502) will then authorize the payment transaction.

The server (502) then transmits (631) a payment confirmation to the merchant device (504) and the mobile phone (506) of the consumer (508), which is subsequently received (632, 633) at the respective devices (504, 506).

It will be appreciated that, since the server requests the location information from the electronic communications device of the consumer, the system and method described above will be particularly useful since the server can inform the delivery agent where the consumer is located to enable delivery of the ordered goods. Also, instead of the server requesting the location information of the electronic communications device of the consumer, the merchant may of course also have a computing device which requests the location information and which then provides the information to the server on a continuous basis.

Furthermore, although the delivery agent is again represented in the drawings as a delivery vehicle in the form of a delivery truck, the system and method may also be implemented by a so called drone or unmanned vehicle. In such an embodiment, the drone or unmanned vehicle may incorporate the mobile communications device and communicate with the server directly.

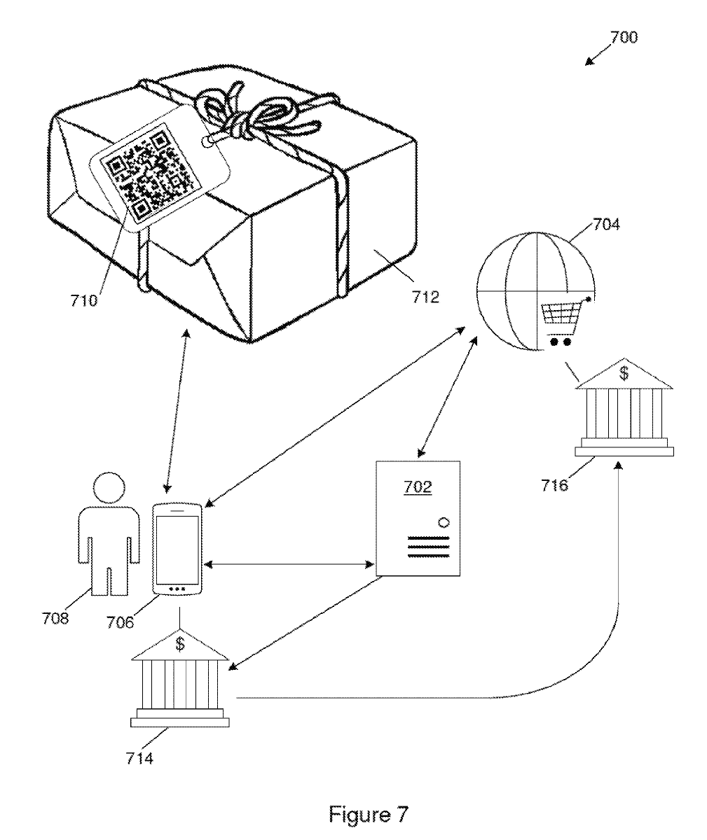

FIG. 7 illustrates a system (700) for authorizing a payment transaction according to a still further alternative embodiment of the invention in which the current location information is provided by use of indicia affixed to the ordered goods. The system (700) includes a server (702) in communication with a merchant device (704) of a merchant, in this embodiment again an e-commerce merchant, and an electronic communications device (706) of a consumer (708). In this embodiment, the electronic communications device (706) is again a mobile phone and includes an optical input (not shown) allowing it to capture visual inputs and, optionally, a location detection system (not shown) which enables the device (706) to determine its current location.

In addition, the system (700) further includes one or more financial institutions, in this embodiment a first bank (714) of the consumer (708) and a second bank (716) of the merchant. It will again be appreciated that the financial institutions do not need to be banks and could also be entities which provide services of a financial nature, such as entities which offer mobile wallet, token, voucher, loyalty card or other services. It will furthermore be appreciated that the first and second banks (714, 716) do not need to be separate entities, but may be two financial accounts managed by the same financial institution, the accounts being associated with the consumer (708) and the merchant respectively.

In this embodiment, when the consumer (708) has placed an order with the merchant and the merchant device (704) transmits a payment request to the server (702), the payment request includes at least one unique identifier associated with the goods to be delivered and, optionally, a desired delivery location specified by the consumer (708) at the time of placing the order with the merchant. In this case, the server (702) will subsequently relay the desired delivery location to the delivery agent. Alternatively, the merchant may relay this desired location directly to the delivery agent.

The packaging of the ordered goods (712) includes one or more indicia (710), in this embodiment one, affixed thereto. This indicia includes information embedded within its visual elements that may be decoded, subsequent to optical capture, by an electronic device equipped with an optical sensor. In this embodiment, the electronic communication device (706) of the consumer, is used for this purpose and the use thereof will subsequently be discussed in greater detail.

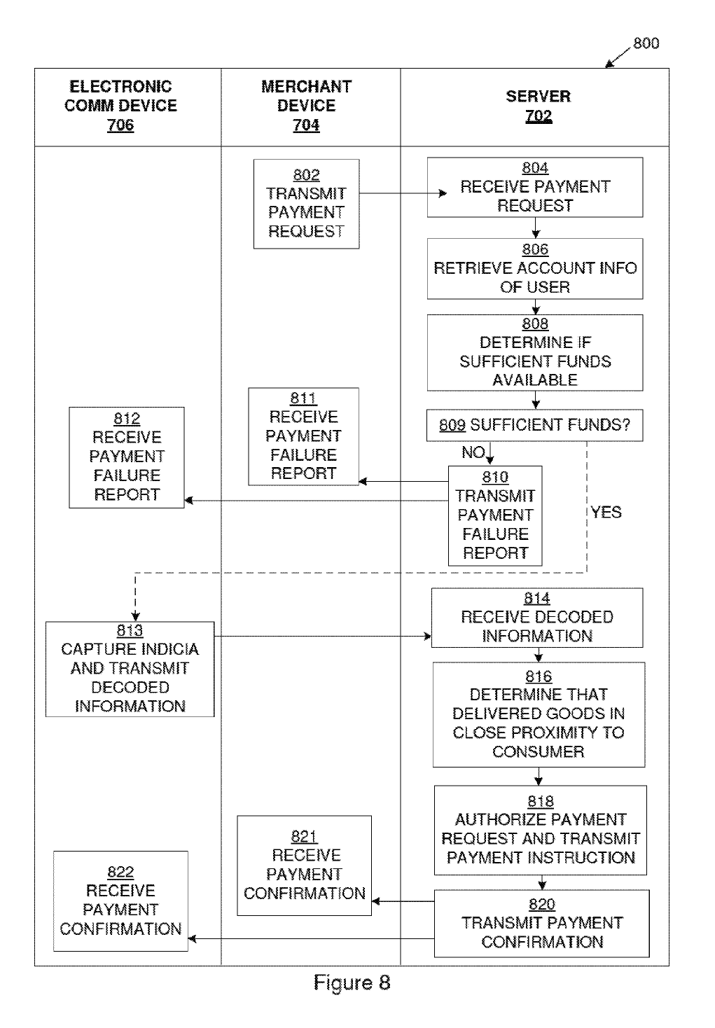

The system (700) of FIG. 7 may be used according to the method described and illustrated in the embodiment of the swim lane diagram (800) of FIG. 8.

Referring to FIG. 8, one embodiment of a method for authorizing a payment transaction is described. When a consumer (708) purchases goods from the e-commerce merchant (704) over the Internet, for example, by using the merchant's e-commerce website on the consumer's mobile phone, the consumer (708) will be required to provide his/her payment credentials as well as delivery information for the delivery of the ordered goods. Once this information has been provided to the merchant device (704), it transmits (802) a payment request to the server (702). The payment request will include the payment credentials of the consumer (708), the delivery information for the delivery of the ordered goods and the payment amount for which payment is requested. The request may also include payment credentials of the merchant to indicate where payment should be made to.

The server (702) then receives (804) the payment request and subsequently retrieves (806) account information associated with the payment credentials of the consumer (704). Once the account information has been retrieved, the server (702) determines (808) whether sufficient funds are available in the account to make payment of the payment amount requested in the payment request. If (809) insufficient funds are available, the server (702) transmits (810) a payment failure report to both the merchant device (704) and the electronic communications device (706) of the consumer (708), which will subsequently be received (811, 812) at the respective devices (704, 706). In this embodiment, the report will be presented to the consumer (708) on the merchant's e-commerce website shortly after the purchase attempt.

Alternatively, if sufficient funds are available, the purchased goods (712) will proceed to a delivery agent. Before being dispatched for delivery, one or more indicia (710) will be affixed to the packaging of the goods (712) which, in this embodiment, is a matrix barcode. This matrix barcode (710) may be generated by the merchant or delivery agent using information provided by the server (702) and embeds a unique identifier associated with the transaction.

When the delivery agent presents the consumer (708) with the purchased goods (712), the consumer (708) captures (813) the indicia (710), in this embodiment a matrix barcode using the optical sensor of the electronic communication device (706), in this embodiment, a digital camera integrated therein. The electronic communication device (706) may be configured to decode the information embedded into the matrix barcode and to transmit the decoded information to the server (702).

The embedded information may include a Uniform Resource Locator (URL) associated with the server (702) and may furthermore include HTTP (Hypertext Transfer Protocol) GET parameters, which are the parameters included in the URL for transmitting data to the server (702). These parameters may include the unique identifier associated with the transaction. Upon capturing the matrix barcode, the electronic communication device may therefore transmit a delivery report, including these parameters and thus also the unique identifier, to the server (702) via the decoded URL. Alternatively, the electronic communication device (706) may execute a software application installed thereon which will decode the information embedded in the indicia (710) and transmit a delivery report to the server (702) including the decoded data and thus also the unique identifier. These are merely exemplary methods whereby the decoded information is sent to the server.

In an alternative embodiment, the encoded indicia data may be sent to the server (702) as part of the delivery report for decoding and subsequent processing, as described hereunder, thereat.

Subsequent to receiving (814) the delivery report, the server (702) will retrieve the details pertaining to the present transaction. The server (702) will then determine (816) that the delivered goods (712) are in close proximity to the electronic communication device (706) of the consumer (708) and, consequently, also in close proximity to the consumer (708). The server (702) will then authorize (818) the payment request and transmit a payment instruction to the financial institution (714) of the consumer (708) to make payment of the payment amount to the financial institution (716) of the merchant. The server (702) then transmits (631) a payment confirmation to the merchant device (704) and the electronic communication device (706) of the consumer (708), which is subsequently received (821, 822) at the respective devices (704, 706).

In one embodiment, the electronic communication device (706) may be configured to determine its current location information subsequent to capturing the indicia information and including the current location information in the delivery report. The server (702) may utilize this location information as a secondary check to confirm that, in addition to the goods (712) being in close proximity to the electronic communication device (706), the delivery was furthermore completed at the specified delivery address. This may be useful for auditing purposes.

In the embodiment wherein the electronic communication device (706) communicates with the server (702) via the decoded URL, the server may obtain the current location information by means of HTML5 Geolocation.

In one embodiment, the indicia may be a bokode, a visual data tag comprising of a tiled series of data matrix code that are readable by means of a digital camera.

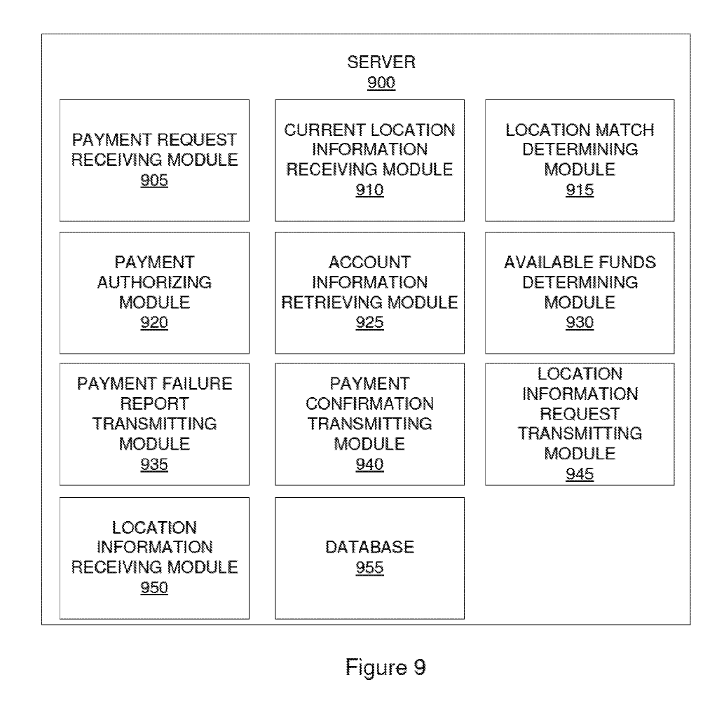

FIG. 9 illustrates an example of a server (900) as used in the described system. The server may include a processor for executing the functions of modules described below, which may be provided by hardware or by software units executing on the server. The software units may be stored in a memory component and instructions may be provided to the processor to carry out the functionality of the described modules.

The server (900) includes a payment request receiving module (905), a current location information receiving module (910), a location match determining module (915) and a payment authorizing module (920). The server (900) may further include an account information retrieving module (925), an available fund determining module (930), a payment failure notification transmitting module (935), a payment confirmation transmitting module (940), a location information request transmitting module (945) and location information receiving module (950).

The payment request receiving module (905) may be used to receive payment requests from merchants for orders for goods placed with the merchants by consumers. For example, in the embodiment described with reference to FIG. 1, the payment request receiving module (905) is used to receive a payment request from the merchant device wherein the payment request includes payment credentials of the consumer as well as delivery information for the delivery of the ordered goods.

The location match determining module (915) may be used to determine whether two or more locations match within a predetermined tolerance. For example, in the embodiments described with reference to FIGS. 1 to 7, a desired delivery location and a current location of the delivery goods may be given as an input to the location match determining module (915). The location match determining module (915) may subsequently provide, as an output, a Boolean true or false value, if the locations respectively match or do not match, or alternatively provide, as an output, a confidence factor expressed as a percentage. The location match determining module (915) may be configured to indicate a match, or a high degree of match confidence, if the current location is within a predetermined radius, or geo-fence, around the desired delivery location.

The account information retrieving module (925) may be used to retrieve account information associated with the received payment credentials. The account information may be retrieved from a database (955). In the embodiment illustrated in FIG. 9, the database (955) is a local database of the server (900), but it could of course also be a database remote of the server (900) which is in data communication with the server (900). Thus, in the embodiment described with reference to FIG. 1, in response to receiving the payment request, the account information retrieving module (925) may be used to retrieve account information, such as available funds in the account, from the database (955).

The available fund determining module (930) may be used to determine whether sufficient funds are available in the account associated with the payment credentials to make payment of the payment amount requested in the payment request. Thus, once the account information has been received, the available fund determining module (930) determines whether sufficient funds are available in the account to make payment to the merchant.

The payment failure notification transmitting module (935) may be used to transmit payment failure notifications to the electronic communications device of the consumer and the merchant device in the event that insufficient funds are available in the account associated with the payment credentials. Thus, once determined that insufficient funds are available, then the payment failure notification transmitting module (935) may be used to transmit a payment failure notification to the electronic communications device of the consumer and the merchant device.

The current location information receiving module (910) may be used to receive current location information. As described above, the current location information may be received from a mobile communications device of the delivery agent delivering the ordered goods, from a communications module attached to the ordered goods, or, in the case where the communications module is not capable of communicating with the current location information receiving module (910), from the electronic communications device of the consumer. The current location information therefore indicates the location of the ordered goods, thus if they have been delivered, then the location will be the delivery location.

In addition, in one embodiment the server (900) may further include a location information request transmitting module (945) which may be used to transmit a location information request to one or more electronic communications devices of the consumer. In this case, the payment request transmitted by the merchant device to the server (900) may include one or more unique identifiers of electronic communications devices of the consumer. The server (900) may be configured to uses these unique identifiers and transmit, via the location information request transmitting module (945), location information requests to the electronic communications devices requesting them to provide their location. In response to the request, the devices may determine their respective location and transmit the location information to the server (900).

In this case, the server (900) may further include a location information receiving module (950) which may be used to receive the location information from the one or more electronic devices of the consumer and to use the location information as the delivery information to which the ordered goods are to be delivered. In one embodiment the server may further be configured to transmit the location information to the mobile communications device of the delivery agent so as to enable the agent to deliver the ordered goods at the location at which the consumer is located.

The location match determining module (915) may be used to determine whether the received current location information matches the delivery information included in the payment request or the location information received by the location information receiving module (950).

The payment authorization module (920) may be used to authorize the payment transaction. Thus, if it is determined that there are sufficient funds available and the current location information matches the delivery information or the received location information, then the payment authorization module (920) may be used to authorize the payment transaction.

The payment confirmation transmitting module (940) may be used to transmit payment confirmation notifications to the communication device of the consumer and the merchant device. Once the payment transaction has been authorised by the payment authorization module (920) and the financial institutions of the consumer has been instructed to pay the financial institution of the merchant, the payment confirmation transmitting module (940) will transmit a payment confirmation to the communication device of the consumer and the merchant device.

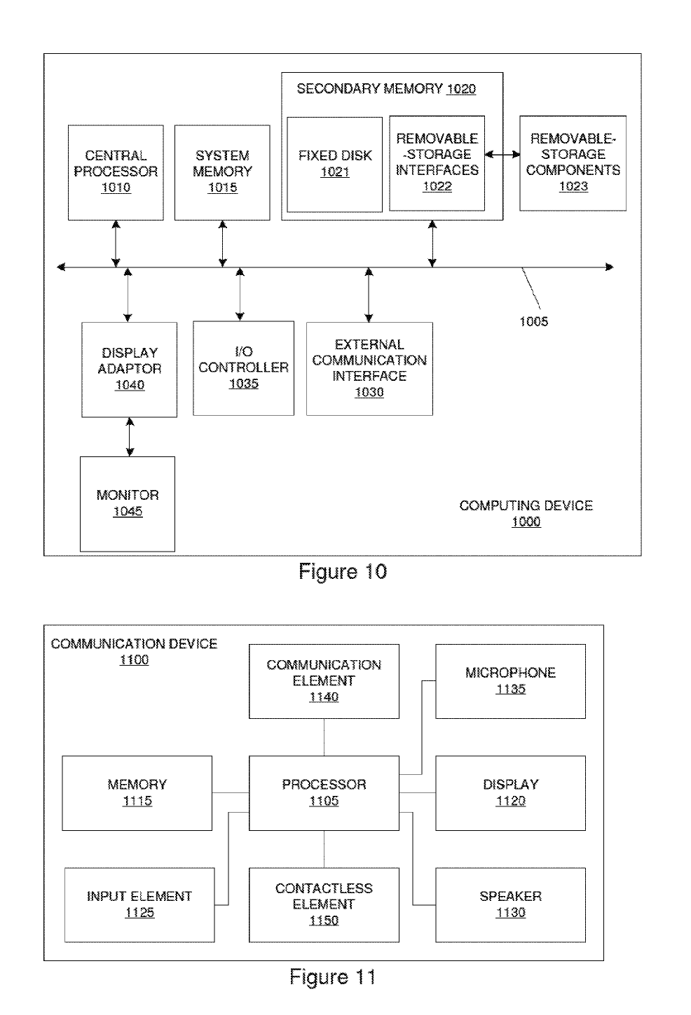

FIG. 10 illustrates an example of a computing device (1000) in which various aspects of the disclosure may be implemented. The computing device (1000) may be suitable for storing and executing computer program code. The various participants and elements in the previously described system diagrams, such as a delivery agent's mobile communications device and, in some embodiments, the consumer's electronic communications device, may use any suitable number of subsystems or components of the computing device (1000) to facilitate the functions described herein. The computing device (1000) may include subsystems or components interconnected via a communication infrastructure (1005) (for example, a communications bus, a cross-over bar device, or a network). The computing device (1000) may include one or more central processors (1010) and at least one memory component in the form of computer-readable media. In some configurations, a number of processors may be provided and may be arranged to carry out calculations simultaneously. In some implementations, a number of computing devices (1000) may be provided in a distributed, cluster or cloud-based computing configuration and may provide software units arranged to manage and/or process data on behalf of remote devices.

The memory components may include system memory (1015), which may include read only memory (ROM) and random access memory (RAM). A basic input/output system (BIOS) may be stored in ROM. System software may be stored in the system memory (1015) including operating system software. The memory components may also include secondary memory (1020). The secondary memory (1020) may include a fixed disk (1021), such as a hard disk drive, and, optionally, one or more removable-storage interfaces (1022) for removable-storage components (1023). The removable-storage interfaces (1022) may be in the form of removable-storage drives (for example, magnetic tape drives, optical disk drives, etc.) for corresponding removable storage-components (for example, a magnetic tape, an optical disk, etc.), which may be written to and read by the removable-storage drive. The removable-storage interfaces (1022) may also be in the form of ports or sockets for interfacing with other forms of removable-storage components (1023) such as a flash memory drive, external hard drive, or removable memory chip, etc.

The computing device (1000) may include an external communications interface (1030) for operation of the computing device (1000) in a networked environment enabling transfer of data between multiple computing devices (1000). Data transferred via the external communications interface (1030) may be in the form of signals, which may be electronic, electromagnetic, optical, radio, or other types of signal. The external communications interface (1030) may enable communication of data between the computing device (1000) and other computing devices including servers and external storage facilities. Web services may be accessible by the computing device (1000) via the communications interface (1030). The external communications interface (1030) may also enable other forms of communication to and from the computing device (1000) including, voice communication, near field communication, radio frequency communications, such as Bluetooth™, etc.

The computer-readable media in the form of the various memory components may provide storage of computer-executable instructions, data structures, program modules, software units and other data. A computer program product may be provided by a computer-readable medium having stored computer-readable program code executable by the central processor (1010). A computer program product may be provided by a non-transient computer-readable medium, or may be provided via a signal or other transient means via the communications interface (1030).

Interconnection via the communication infrastructure (1005) allows the central processor (1010) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, and the like) may couple to the computing device (1000) either directly or via an I/O controller (1035). These components may be connected to the computing device (1000) by any number of means known in the art, such as a serial port. One or more monitors (1045) may be coupled via a display or video adapter (1040) to the computing device (1000).

FIG. 11 shows a block diagram of a communication device (1100). The various participants and elements in the previously described system diagrams, such as a delivery agent's mobile communications device and, in some embodiments, the consumer's electronic communications device, may use any suitable number of subsystems or components of the communication device (1100). The communication device (1100) may be a cell phone, a feature phone, a smart phone, a satellite phone, or a computing device having a phone capability.

The communication device (1100) may include a processor (1105) (e.g., a microprocessor) for processing the functions of the communication device (1100) and a display (1120) to allow a user to see the phone numbers and other information and messages. The communication device (1100) may further include an input element (1125) to allow a user to input information into the device (e.g., input buttons, touch screen, etc.), a speaker (1130) to allow the user to hear voice communication, music, etc., and a microphone (1135) to allow the user to transmit his or her voice through the communication device (1100). The processor (1110) of the communication device (1100) may connect to a memory (1115). The memory (1115) may be in the form of a computer-readable medium that stores data and, optionally, computer-executable instructions.

The communication device (1100) may also include a communication element (1140) for connection to communication channels (e.g., a cellular telephone network, data transmission network, Wi-Fi™ network, satellite-phone network, Internet network, Satellite Internet Network, etc.). The communication element (1140) may include an associated wireless transfer element, such as an antenna. The communication element (1140) may include a subscriber identity module (SIM) in the form of an integrated circuit that stores an international mobile subscriber identity and the related key used to identify and authenticate a subscriber using the communication device (1100). One or more subscriber identity modules may be removable from the communication device (1100) or embedded in the communication device (1100).

The communication device (1100) may further include a contactless element (1150), which is typically implemented in the form of a semiconductor chip (or other data storage element) with an associated wireless transfer element, such as an antenna. The contactless element (1150) may be associated with (e.g., embedded within) the communication device (1100) and data or control instructions transmitted via a cellular network may be applied to the contactless element (1150) by means of a contactless element interface (not shown). The contactless element interface may function to permit the exchange of data and/or control instructions between mobile device circuitry (and hence the cellular network) and the contactless element (1150). The contactless element (1150) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth™, infra-red, or other data transfer capability that can be used to exchange data between the communication device (1100) and an interrogation device. Thus, the communication device (1100) may be capable of communicating and transferring data and/or control instructions via both a cellular network and near field communications capability.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™ C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A method of authorizing a payment transaction, the method being carried out at a server and comprising:
receiving a payment request for an order of goods placed by a consumer with a merchant, the payment request associated with payment credentials of the consumer and delivery information for the delivery of the ordered goods;
receiving current location information of the ordered goods;
determining whether the received current location information matches the received delivery information; and
if the received current location information matches the received delivery information within acceptable parameters, authorizing the payment request.

2. A method as claimed in claim 1, wherein the delivery information includes a delivery location.

3. A method as claimed in claim 1, wherein the delivery information includes a unique identifier associated with an electronic communications device of the consumer.

4. A method as claimed in claim 3, wherein the server is configured to transmit a location information request to the electronic communications device identified by the unique identifier to prompt the device to transmit location information of the device to the server; and to, subsequent to receipt thereof, utilise the received location information as delivery information to which the ordered goods are to be delivered.

5. A method as claimed in claim 1, including pre-processing a payment request prior to determining whether the received current location information matches the received delivery information and authorizing the payment request if a match is determined.

6. A method as claimed in claim 1, wherein receiving the current location information of the ordered goods includes receiving the current location information by the server from a mobile communications device associated with a delivery agent delivering the ordered goods.

7. A method as claimed in claim 1, wherein receiving the current location information of the ordered goods includes receiving the current location information by the server from a communications module affixed to the ordered goods.

8. A method as claimed in claim 1, wherein receiving the current location information of the ordered goods includes receiving the current location information by the server from an electronic communications device of the consumer.

9. A method as claimed in claim 8, wherein the current location information originates from a communications module affixed to the ordered goods and is transmitted via the electronic communications device of the consumer.

10. A method as claimed in claim 8, wherein the current location information originates from a mobile communication device of a delivery agent and is transmitted via the electronic communications device of the consumer.

11. A method as claimed in claim 1, including receiving a delivery confirmation from an electronic communications device of the consumer including information captured from indicia affixed to the ordered goods, the indicia being encoded with at least one unique identifier associated with the payment transaction that is transmitted via the electronic communications device of the consumer to the server.

12. A method as claimed in claim 11, wherein receiving delivery confirmation captured from the indicia includes decoded information encoded within the indicia.

13. A method as claimed in claim 11, wherein receiving delivery confirmation captured from the indicia includes encoded information and wherein the method includes the server decoding the information included in the indicia.

14. A method as claimed in claim 11, wherein the delivery confirmation furthermore includes the location of the electronic communication device.

15. A method as claimed in claim 11, wherein the server is furthermore configured, subsequent to receiving the delivery confirmation, to determine that the delivered goods are in close proximity to the electronic communication device and therefore that the current location information of the delivered goods matches the delivery information.

16. A system for authorizing a payment transaction comprising a server including:
a payment request receiving module for receiving a payment request for an order of goods placed by a consumer with a merchant, the payment request associated with payment credentials of the consumer and delivery information for the delivery of the ordered goods;
a current location information receiving module for receiving current location information of the ordered goods;
a location match determining module for determining whether the received current location information matches the received delivery information; and
a payment authorization module for authorizing the payment request if the received current location information matches the received delivery information within acceptable parameters.

17. A system as claimed in claim 16, including a location information request transmitting module configured to transmit a location information request to an electronic communications device identified by a unique identifier in the delivery information to prompt the device to transmit location information of the device to the server.

18. A system as claimed in claim 16, including an available funds determining module for pre-processing a payment request prior to determining whether the received current location information matches the received delivery information and a payment authorizing module for authorizing the payment request if a match is determined.

19. A system as claimed in claim 16, wherein the current location information receiving module for receiving the current location information of the ordered goods includes receiving the current location information from a mobile communications device associated with a delivery agent delivering the ordered goods.

20. A system as claimed in claim 16, wherein the current location information receiving module for receiving the current location information of the ordered goods includes receiving the current location information from a communications module affixed to the ordered goods.

21-26. (canceled)
